(19) United States
(12) Patent Application Publication
(10) Pub. No.: US 2015/0167852 A1
(43) Pub. Date: Jun. 18, 2015

(54) HIGH PRESSURE GLAND THRUSTER AND VALVE

(71) Applicant: Mogas Industries, Inc., Houston, TX (US)

(72) Inventors: Duc Thanh Tran, Spring, TX (US); Alfred Lewis Anderson, Houston, TX (US)

(73) Assignee: Mogas Industries, Inc., Houston, TX (US)

(21) Appl. No.: 14/106,501

(22) Filed: Dec. 13, 2013

(51) Int. Cl. F16K 5/06; F16K 5/20

(52) U.S. Cl. CPC F16K 5/0694; F16K 5/20

(57) ABSTRACT

Gland thruster reinforced for high pressure application and valve incorporating the gland thruster. Methods to use the gland thruster and valve are also disclosed.

### BACKGROUND

Valves are often subjected to extremely high pressures and temperatures in the various processes where they are used. Leaking past seals associated with the closure members such as valve stem packing presents operational issues. The tendency for valves to leak increases under conditions of high pressure and high temperature, which are known to occur in service valves which operate through a wide range of temperatures. The art is desirous of design improvements to valves to minimize the occurrence and rate of leaks, mitigate damage to the valve and valve components in the event of a leak, facilitate discovery and investigation of leak locations and issues and/or to allow operation of valves at ever higher pressures and/or temperatures.

### SUMMARY

The instant disclosure is directed to a reinforced gland thruster to compress a packing system disposed radially around a valve stem in a packing bore. In an embodiment, a sleeve comprises an outside diameter adjacent to an inside diameter of the packing bore, an inside diameter adjacent to an outside diameter of the valve stem, and a distal end disposed to compress the packing system. In an embodiment, a flange is located at a proximal end of the gland thruster, and a reinforced section is located intermediate the sleeve and the flange which has a wall thickness greater than a wall thickness of the sleeve.

In another embodiment, a valve comprises a valve body comprising a fluid flow path through a cavity, a flow control element located within the cavity, a valve seat to form a fluid seal between the flow control element and the valve body, a valve stem extending from a proximal end (away from the flow bore axis, adjacent any valve operator), through a packing bore formed in the valve body and disposed radially around the valve stem, to a distal end in rotational engagement with the flow control element to rotate the flow control element between open and closed positions by rotating the valve stem, and the gland thruster which is disposed radially around the valve stem to compress a packing system disposed radially around the valve stem in the packing bore and comprising a plurality of packing rings and at least one proximal anti-extrusion ring disposed between the valve thruster and the packing rings.

In another embodiment, a method of operating the valve comprises introducing a pressurized fluid into the flow path through the cavity formed in the valve body, rotationally engaging the flow control element with the distal end of the valve stem, rotating the valve stem to rotate the flow control element between open and closed position for a plurality of cycles, and distally biasing the gland thruster to compress the packing system to maintain a fluid tight seal between the valve stem and the packing bore during at least one of the plurality of cycles of rotation of the valve stem.

### BRIEF DESCRIPTION OF THE DRAWINGS

FIG. 1 is an end view of one embodiment of a ball valve according to the instant disclosure;

FIG. 2 is a side sectional view of the ball valve as seen along the lines 2-2 in FIG. 1;

FIG. 3 is an enlarged view of detail 3 shown in FIG. 2;

FIG. 4 is an enlarged view of detail 4 shown in FIG. 2;

FIG. 5 is an enlarged side view, partly in section, of the stem-ball assembly from FIG. 2;

FIGS. 6A-6B are sectional views of the stem-ball assembly as seen along the lines 6-6 in FIG. 5, showing application of fluid pressure;

FIG. 6C is a sectional view of the stem-ball assembly as seen along the lines 6-6 in FIG. 5, showing rotational interengagement of the stem and ball;

FIGS. 7A and 7B show an enlarged view of detail 7 shown in FIG. 2, before and after compression of the packing system by the reinforced gland thruster, respectively, according to the instant disclosure;

FIG. 8 is a perspective view of one embodiment of a gland thruster according to the instant disclosure;

FIG. 9 is a bottom view of the gland thruster of FIG. 8;

FIG. 10 is a side sectional view of the gland thruster as seen along the lines 10-10 in FIG. 9;

FIG. 11 is an enlarged schematic view of the gland thruster-valve stem assembly of FIG. 7 showing leak egress paths and a sight line within a range of observation angles according to one embodiment of the instant disclosure.

### DETAILED DESCRIPTION

Detailed embodiments are disclosed herein. However, it is understood that the disclosed embodiments are merely exemplary of the disclosure, which may be embodied in various forms. Specific structural and functional details disclosed herein are not intended to be limiting, but merely illustrations that can be modified within the scope of the attached claims.

As used herein, “closely approximating” diameters in reference to opposing radial surfaces refers to diameters that are within 0.75 mm (0.03 in.), whereas “matching” diameters refers to diameters that are within 0.25 mm (0.01 in.). In embodiments of closely approximating or matching diameters, an outside diameter of the inner radial surface may be equal to or less than an inside diameter of the outer radial surface. In embodiments, the matching diameters may be within 0.20 mm (0.008 in.), or within 0.13 mm (0.005 in.), or within 0.076 mm (0.003 in.), or within 0.051 mm (0.002 in.) or within 0.025 mm (0.001 in.).

As used herein, “concentric” refers to an item such as a shaft or bore having a cylindrical surface with a longitudinal axis that along the length of the item is within 3.2 mm (0.13 in.) of the radius of the cylindrical surface, or the radius of a reference surface. In embodiments, the axis, along its length, may be within 2.0 mm (0.08 in.), or within 1.3 mm (0.05 in.), or within 0.76 mm (0.03 in.), or within 0.51 mm (0.02 in.), or within 0.25 mm (0.01 in.), or within 0.20 mm (0.008 in.), or within 0.13 mm (0.005 in.), or within 0.076 mm (0.003 in.), or within 0.051 mm (0.002 in.) or within 0.025 mm (0.001 in.), of the radius of the cylindrical or reference surface.

As used herein, “compression delta” refers to the height or length of a component or assembly with zero compression (original height or length) minus the height or length of the compressed component or assembly.

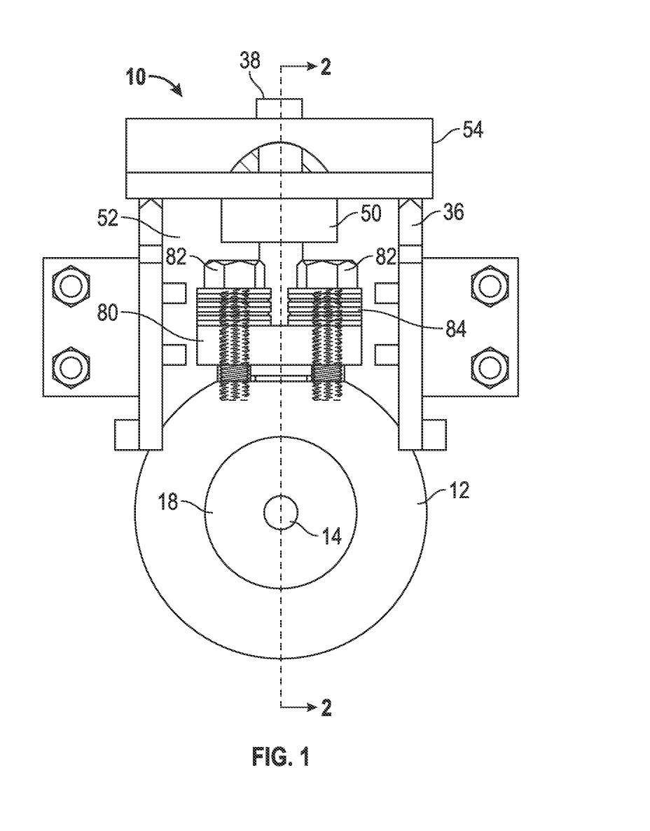

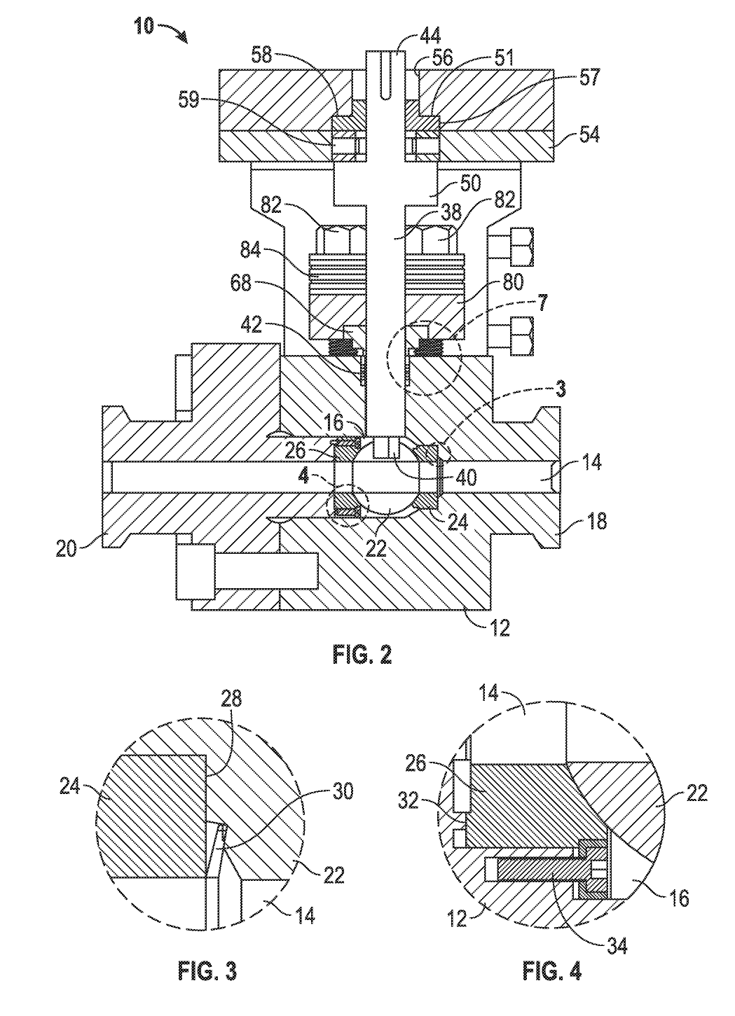

The instant disclosure in one embodiment is directed to a ball valve suitable for the selective passage and isolation of fluid under high pressure, and a method of using the valve in a high pressure environment. Referring to FIGS. 1 and 2, in an embodiment ball valve 10 includes a valve body 12 comprising one piece or preferably two pieces. A fluid flow path 14 is formed by axial bores into a valve cavity 16 from opposite ends 18, 20, which for convenience herein, are respectively referred to as the inlet and outlet ends. The inlet end 18 is normally intended to be the high pressure side, but the valve 10 may be bidirectional and/or may be operated with the outlet end 20 connected to the high pressure fluid source.

In an embodiment, a flow control assembly comprises a flow control element 22, which may be a ball as illustrated, located within the valve cavity 16 and disposed in sealing contact with opposing annular, spherical surfaces of the inlet valve seat 24 (See FIG. 3) and outlet valve seat 26 (See FIG. 4). As shown in FIG. 3, inlet valve seat 24 may comprise an annular sealing surface 28 dimensioned and arranged for sealing against an opposing surface of the valve body 12. In an embodiment, a spring 30 may be positioned in an annular recess between inlet seat 24 and valve body 12 to bias the flow control element 22 against the outlet seat 26. As shown in FIG. 4, outlet seat 26 may comprise an annular sealing surface 32 dimensioned and arranged for sealing against an opposing surface of the valve body 12. In an embodiment, outlet seat 26 may be secured to valve body 12 using a plurality of threaded members 34 such as screws engaged with an outer radial edge of outlet seat 26 and valve body 12.

In an embodiment, a bracket 36 has a lower or distal end attached to valve body 12, and an upper or proximal end spaced laterally therefrom to retain a valve stem 38. As used herein, proximal or upper or sometimes outer refer to a position located away from or towards a direction away from the axis of the flow path 14, whereas distal or lower or sometimes inner refer to a position located adjacent or towards the axis of the flow path 14. Upper or lower in this context only refer to the orientation shown in the drawings, since the valve 10 may be positioned in use with the valve stem 38 positioned horizontally or extending below the valve 10 or at any angle between.

The stem 38 has a distal end 40 engaging flow control element 22 and extends through a packing bore 42 in valve body 12 to a proximal end 44. The flow control element 22 is rotatable between a closed position as shown in FIG. 1, and an open position as shown in FIG. 2 wherein the flow control element 22 is rotated 90 degrees about the axis of the stem 38 from the closed position. In the open position, a bore through the flow control element 22 is aligned with the axial bores of the flow path 14, whereas in the closed position the bore through the flow control element 22 is transverse to block the flow path 14. The flow control element 22 may, if desired, be partially rotated between open and closed for throttling or controlling the rate of fluid flow.

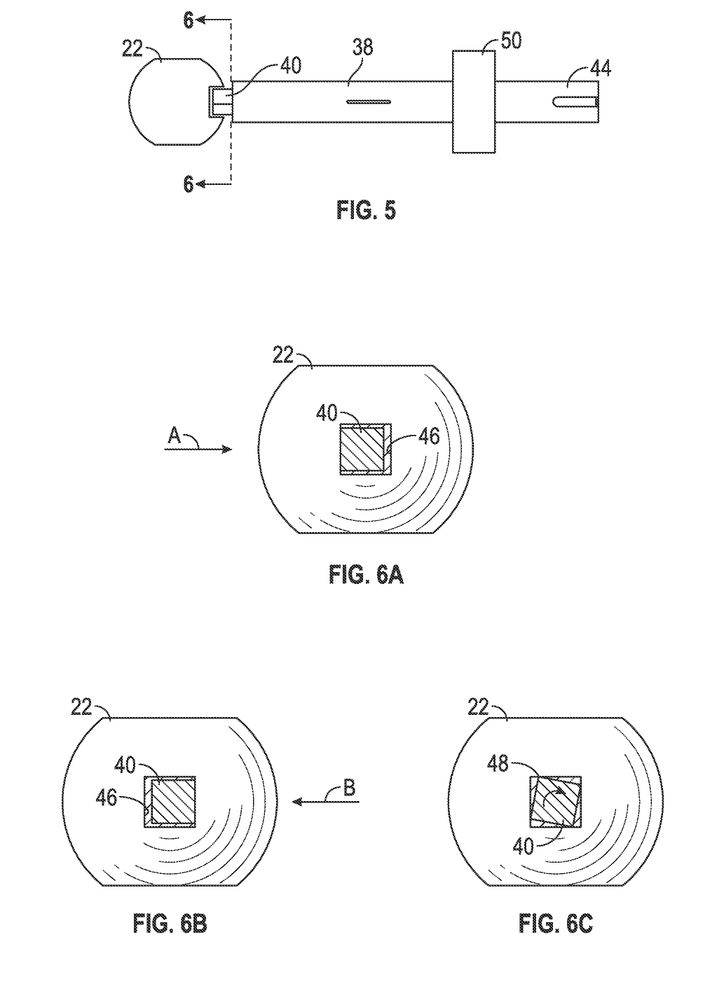

With reference to FIGS. 5 and 6A-6B, valve stem 38 may engage flow control element 22 with distal end 40 received in a recess 46 formed in the flow control element 22. The distal end 40 and recess 46 are dimensioned and arranged to have similar cross-sectional profiles, e.g., polygonal, preferably rectangular, more preferably square, as best seen in FIGS. 6A and 6B. In an embodiment, recess 46 is oversized relative to the distal end 40 by an amount sufficient to allow movement of the flow control element 22 in the closed position, e.g., towards either of the inlet and outlet ends 18, 20 when pressurized fluid is introduced into the flow path 14 at an opposite end. As used herein the term “oversized” refers to the closed position axial dimension of the recess 46 (transverse to the bore in the flow control element 22) being intentionally made larger than the closed position axial dimension of the distal end 40 by an amount greater than normal tolerances would require.

In embodiments, the dimension of the distal end 40 closely approximates the oversized dimension of the recess 46 to facilitate bidirectional sealing between the flow control element 22 and the valve body 12. In FIGS. 6A and 6B, pressure is applied in direction A and direction B, respectively, and displaces the flow control element 22 in the same direction relative to the distal end 40 of the valve stem 38, and the recess 46 is dimensioned so as to allow sufficient axial movement to avoid preventing the flow control element from seating at the respective valve seat on the low pressure side. In embodiments, the distance between the sides of recess 46 are dimensioned relative to the distance between the sides of the distal end 40 to allow for an amount of axial movement of the flow control element 22 of less than about 0.3 mm, or 0.2 mm, or 0.1 mm, or 0.05 mm, or 0.01 mm, or 0.005 mm, or 0.001 mm.

With reference to FIG. 6C, the stem-ball configuration in embodiments herein may also facilitate operation of the valve 10 for rotation of the flow control element 22, especially if torque requirements are high due to the high pressure of the fluid in the flow path 14. In embodiments, the distal end 40 of the valve stem 38 comprises a polygonal profile comprising a plurality of stem profile sides dimensioned and arranged to engage a recess 46 formed in the flow control element having a corresponding polygonal profile with a like plurality of recess sides, wherein rotation of the valve stem 38 is transmitted to the flow control element 22 through a like plurality of contact points 48 between the stem profile sides and the recess sides. Rotation of the distal end 40 about the axis of the stem 38 produces some rotation of the stem 38 relative to the flow control element 22, corresponding to the clearances between the surfaces of distal end 40 and the recess 46. By providing relatively equal tolerances between each of the plurality of opposing surfaces, a like plurality of contact points 48 are established, viz., four contact points 48 in the case of the square profile embodiment illustrated, three for a triagonal profile, five for a pentagonal profile, six for a hexagonal profile, etc. The increased number of contact points 48 facilitates distribution of the mechanical stresses among the contact points 48 and reduces the maximum stress relative to a lesser number of rotational contacts. In an embodiment, the valve stem comprises a metal alloy heat treated to greater than or equal to about 1034 MPa (150 kpsi) yield as determined by ASTM C774 or an equivalent thereof.

In embodiments, the valve 10 may be provided with a blow-out stop feature to inhibit forceful ejection of the stem 38, e.g., a shoulder 50 formed on the valve stem 38 with an enlarged outside diameter greater than an inside diameter of a blow-out stop 51 disposed radially around the valve stem between the proximal end of the valve stem 38 and the shoulder 50. The shoulder 50 may be disposed in an access area 52 within bracket 36 below an operator mounting platform assembly 54, as best seen in FIGS. 1-2. In an embodiment, a diameter of the shoulder 50 is greater than an inside diameter of an outer bracket bore 56 and less than an inside diameter of inner bracket bore 57, wherein the inner bracket bore 57 has a larger diameter than the outer bracket bore 56 formed in the platform assembly 54. In an embodiment, the bore 56 is coaxial with the valve stem 38, shear bushing 58 and thrust bearing 59, which may be disposed between the stem shoulder 50 and platform assembly 54 to facilitate alignment and rotation of the stem 38. In an embodiment, the shear bushing 58 may have an outside diameter larger than the inside diameter of upper bracket bore 56, and an inside diameter less than the diameter of stem shoulder 50. In embodiments, the shear bushing 58 may have an upper portion with a diameter closely approximating or matching that of the upper bracket bore 56 and a lower portion with a diameter closely approximating or matching that of the inner bracket bore 57. In this manner, the shear bushing 58 may be retained on the blow-out-stop 51.

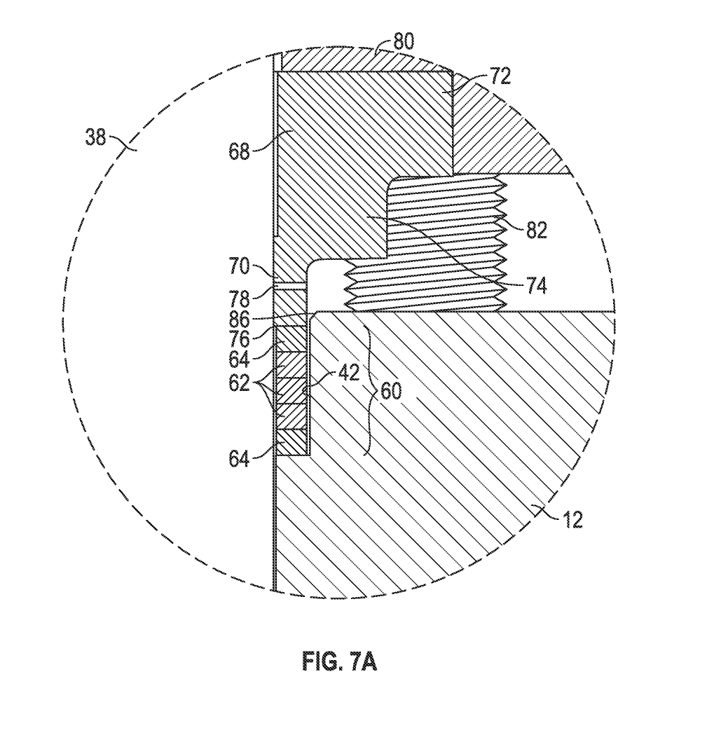

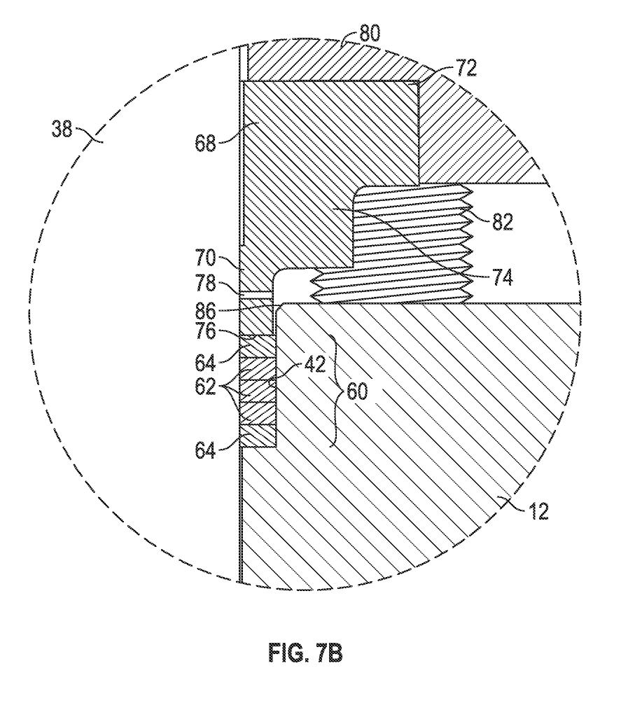

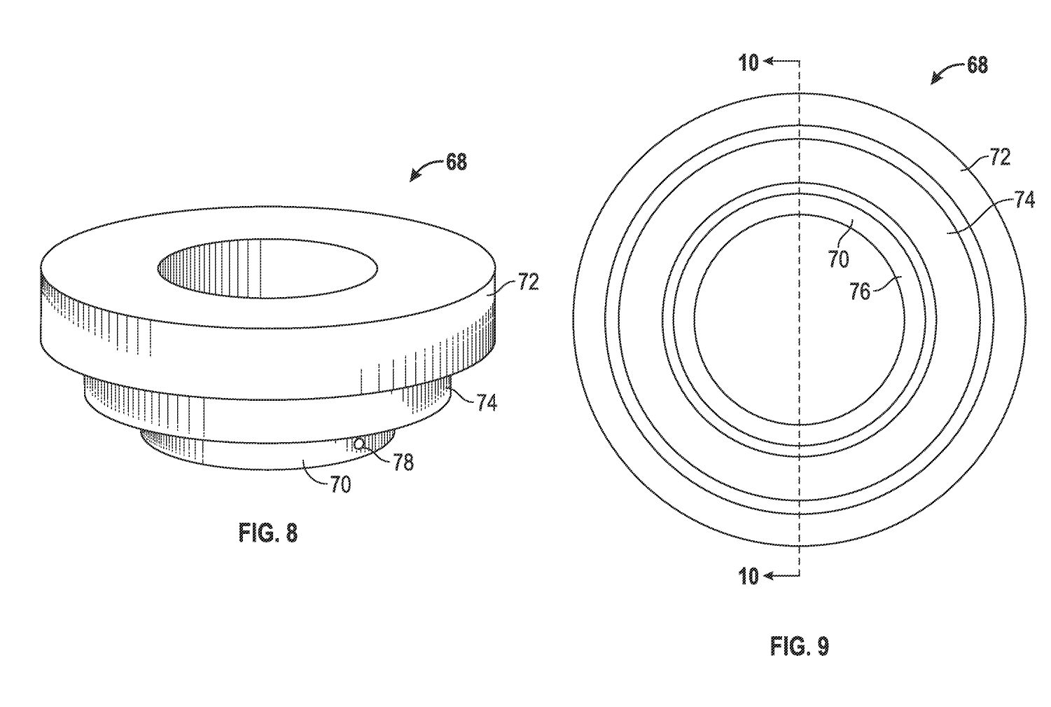

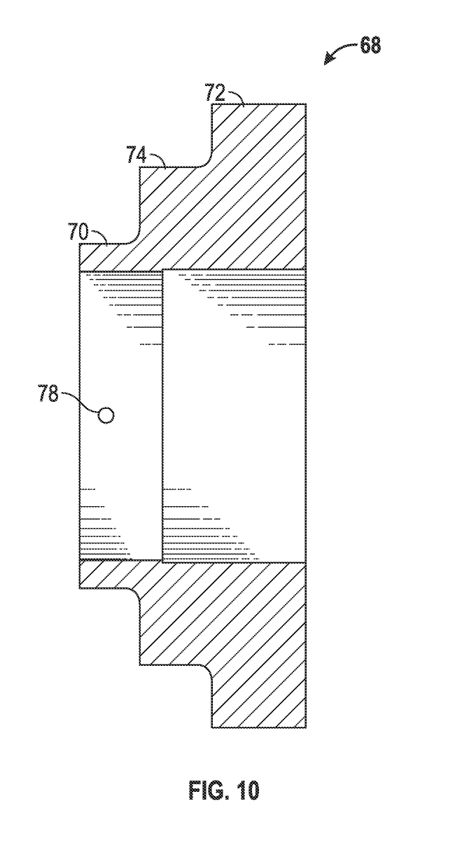

With reference to FIGS. 7A and 7B, in an embodiment a packing system 60 is disposed radially around the valve stem 38 in the packing bore 42. In embodiments, the packing system 60 may comprise a plurality of packing rings 62, a proximal anti-extrusion ring 64, and optionally a distal anti-extrusion ring 66, each having an inner diameter closely approximating or matching the diameter of valve stem 38, and an outer diameter closely approximating or matching the inside diameter of the packing bore 42. A distally biased gland thruster 68 is disposed radially around the valve stem 38 to compress the packing system 60 to form a seal, preferably fluid-tight, between the valve stem 38 and the packing bore 42. FIG. 7A shows the arrangement of the gland thruster 68 and packing system 60 prior to compression, and FIG. 7B shows the arrangement with active compression of the packing system 60 by the gland thruster 68.

In embodiments, the gland thruster 68 is provided with a distal sleeve 70, a proximal flange 72 and an intermediate section 74 between the sleeve and the flange. In embodiments, the sleeve 70 comprises an outside diameter closely approximating or matching an inside diameter of the packing bore 42, an inside diameter closely approximating or matching an outside diameter of the valve stem 38, and a distal end 76 disposed to compress the packing system 60. The intermediate section 74 is structurally reinforced with a wall thickness greater than a wall thickness of the sleeve 70, and may optionally have wall thickness at least 2 mm (0.080 in.) more than a wall thickness of the sleeve, preferably at least 4 mm (0.16 in.) more, or 8 mm (0.31 in.) more. The reinforcement provides strength to facilitate resistance to deformation of the gland thruster 68 should high pressure fluid become trapped between the gland thruster 68 and the stem 38.

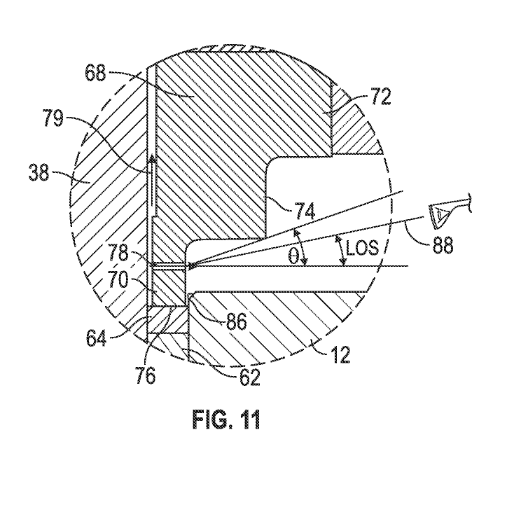

In embodiments, one or more transverse weep holes 78 may be formed in the sleeve 70 as a further means of venting fluid from the annulus between the stem 38 and gland thruster 68. In embodiments, two weep holes 78 are provided on opposite sides of the sleeve 70. The weep holes in embodiments preferably have a diameter from 1 to 2 mm, or a diameter of about 1.5 mm. As illustrated in FIG. 11, fluid egress may be provided through an annulus 79 between the gland thruster 68 and the stem 38; however, the weep holes 78 serve to provide an additional and/or alternate fluid egress in the event of a leak past the packing system 60.

In embodiments best seen in FIGS. 1 and 2, a gland thruster cap 80 is disposed radially around the valve stem 38 and adjacent the flange 72. The cap 80 is distally biased against the gland thruster 68 by a plurality of compression bolts 82 threaded into the valve body 12. In embodiments, the bolts 82 may be tensioned by respective springs 84. By using a plurality of spring-tensioned bolts 82 and the cap 80/gland thruster 68 arrangement, the pressure can be concentrated to the surface area of the distal end 76 of the sleeve 70 to provide the compression necessary to hold the packing system 60 in place and provide a seal even at very high pressures.

In embodiments, a chamfer 86 may be provided at the proximal end of the packing bore 42 to help align and insert the sleeve 70. In embodiments, the intermediate section 74, e.g., at a distal face, may be spaced away from a surface of the valve body 12 adjacent the packing bore 42 at a distance within 25% (post-compression, e.g., FIG. 7B) to 125% (pre-compression, e.g., FIG. 7A) of the compression delta of the packing system 60, where compression delta is defined as the height of the packing with no compression minus the height of the compressed packing system. The spacing provides a margin for compression of the packing system 60 over the life of the seal, since if the intermediate section 74 bottoms the compression of the packing system 60 may be inadequate to maintain a seal, whereas an excessive length of the sleeve 70 above the packing bore 42 may result in inadequate reinforcement of the gland thruster 68.

In embodiments, the outside diameter of the intermediate section 74 and the spacing of the intermediate section above the valve body 12 provides a line of sight (LOS) 88 to the weep holes 78 which is within a range of observation angles Θ spanning at least 20 degrees, preferably at least 25 degrees, as best seen in FIG. 11. For example, if the proximal surface of the valve body 12 adjacent the packing bore 42 is horizontal, one should be able to visually observe the weep holes 78 for leakage at an LOS 88 an observation angle of at least 20 degrees above horizontal.

In an embodiment, the packing system 60 comprises a thermoplastic packing ring assembly of one or more thermoplastic packing rings sandwiched between, and in physical contact with an intermediate sealing ring assembly comprising at least one proximal and at least one distal sealing ring sandwiched between, and in physical contact with an anti-extrusion ring assembly comprised of the proximal anti-extrusion ring 64 and the distal anti-extrusion ring 66. In an embodiment, the intermediate sealing rings may have a hardness which is greater than the hardness of thermoplastic packing ring(s), and/or the anti-extrusion rings 64, 66, may have a hardness which is greater than a hardness of the intermediate sealing rings.

In an embodiment, the thermoplastic packing rings and/or the intermediate sealing rings may comprise an engineering thermoplastic selected from the group consisting of a polycarbonate resin, a polyamide resin, a polyester resin, a polyether ether ketone resin, a polyacrylate resin, a polybutylene naphthalate resin, a liquid crystal polyester, a polyoxalkylene diimide diacid/polybutyrate terephthalate copolymer, a nitrile resin, polyoxymethylene resin, a styrene-acrylonitrile copolymer, a methacrylonitrile-styrene copolymer, a methacrylonitrile-styrene-butadiene copolymer; an acrylate resin, a polyvinyl acetate, a polyvinyl alcohol, an olefinic chloride or other halide resin, a fluoride resin, a cellulose resin, a polyimide resin, a polysulfone resin, a polyacetal resin, a polylactone resin, a polyketones, a polyphenylene oxide resin, a polyphenylene oxide/polystyrene resin, a polyphenylene sulfide resin, a styrene resin, an acrylonitrile-butadiene-styrene resin, a polyolefin resin, and a combination thereof.

Suitable engineering thermoplastics for use herein include polycarbonates, such as poly(bisphenol-a carbonate); polyamide resins, such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, and nylon 66/PPS copolymer; polyester resins, such as polybutylene terephthalate (PBT), polyethylene terephthalate (PET), polyethylene isophthalate (PEI), PET/PEI copolymer, polyether ether ketone (PEEK), polyacrylate (PAR), polybutylene naphthalate (PBN), liquid crystal polyester, polyoxalkylene diimide diacid/polybutyrate terephthalate copolymer, and other aromatic polyesters; nitrile resins, such as polyacrylonitrile (PAN), polymethacrylonitrile, polyoxymethylene (POM), also known as acetal, polyacetal, and polyformaldehyde (Delrin™), styrene-acrylonitrile copolymers (SAN), methacrylonitrile-styrene copolymers, and methacrylonitrile-styrene-butadiene copolymers; acrylate resins, such as polymethyl methacrylate and polyethylacrylate; polyvinyl acetate (PVAc); polyvinyl alcohol (PVA); chloride resins, such as polyvinylidene chloride (PVDC), and polyvinyl chloride (PVC); fluoride resins, such as polyvinylidene fluoride (PVDF), polyvinyl fluoride (PVF), polychlorofluoroethylene (PCFE), and polytetrafluoroethylene (PTFE); cellulose resins, such as cellulose acetate and cellulose acetate butyrate; polyimide resins, including aromatic polyimides; polysulfones; polyacetals; polylactones; polyketones, including aromatic polyketones; polyphenylene oxide; polyphenylene oxide/polystyrene (Noryl), polyphenylene sulfide; styrene resins, including polystyrene, styrene-maleic anhydride copolymers, and acrylonitrile-butadiene-styrene (ABS) resin, polyolefins such as high density polyethylene, ultrahigh molecular weight polyethylene, combinations thereof, and the like.

In an embodiment, the thermoplastic packing rings may comprise a thermoplastic resin selected from the group consisting of polyvinyl fluoride (PVF), polychlorofluoroethylene (PCFE), polytetrafluoroethylene (PTFE); and combinations thereof. In an embodiment, the intermediate sealing rings may comprise a thermoplastic resin selected from the group consisting of a polyamide, polyphenylene oxide/polystyrene, polyoxymethylene (POM), polyether ether ketone (PEEK), and combinations thereof.

In an embodiment, the thermoplastic packing rings may have a Rockwell R hardness determined according to ASTM D785 or an equivalent thereof, which is less than the Rockwell R hardness of the intermediate sealing rings. In an embodiment, the Rockwell R hardness of the intermediate sealing rings is less than the Rockwell R hardness of the anti-extrusion rings. In an embodiment, the thermoplastic packing rings may have a Rockwell R hardness of less than or equal to about 100R, or less than or equal to about 90R, or less than or equal to about 80R, or less than or equal to about 70R, or less than or equal to about 60R, or less than or equal to about 50R, or less than or equal to about 40R, or less than or equal to about 30R, or less than or equal to about 20R, or less than or equal to about 15R.

In an embodiment, the intermediate sealing rings may have a Rockwell R hardness of greater than about 100R, or greater than or equal to about 105R, or greater than or equal to about 110R, or greater than or equal to about 115R, or greater than or equal to about 120R, or greater than or equal to about 125R, or greater than or equal to about 130R determined according to ASTM D785 or an equivalent thereof.

In an embodiment, the Rockwell R hardness of any one of the intermediate sealing rings may be greater than the Rockwell R hardness of any one of the thermoplastic packing rings of the valve packing by at least 50R units, or by at least 60R units, or by at least 70R units, or by at least 80R units, or by at least 90R units, or by at least 100R units, or by at least 110R units determined according to ASTM D785 or an equivalent thereof.

In an embodiment, the anti-extrusion rings 64, 66 may comprise brass, steel, titanium, silicon carbide, an at least partially austenitic steel alloy, or a combination thereof. In an embodiment, the anti-extrusion rings 64, 66 comprise an austenitic iron alloy further comprising chromium, nickel, manganese, silicone, nitrogen, carbon, molybdenum, titanium, niobium, or a combination thereof. Suitable examples include various stainless steels (SS) including XM-19, 303, 304/304L, 309, 310, 321, 347, 410, 416, Inconel 718, 15-5, 17-4PH, 17-4 H1025, 17-4 H1075, 17-4 H1150, 17-4 HH1150, NITRONIC 50, NITRONIC 60, A286, and combinations thereof. In an embodiment, the anti-extrusion rings 64, 66 comprise an austenitic steel alloy comprising iron, chromium, nickel, manganese, silicone, and nitrogen. Suitable examples include Nitronic 50 and Nitronic 60 stainless steel.

In an embodiment, the valve 10 may be used to selectively pass or isolate a high pressure fluid. In an embodiment, operation of the valve may comprise introducing a pressurized fluid into the flow path 14 through the cavity 16 formed in the valve body 12; rotationally engaging the flow control element 22 with the distal end 40 of the valve stem 38; rotating the valve stem 38 to rotate the flow control element 22 between open and closed position for a plurality of cycles; and distally biasing the gland thruster 68 to compress the packing system 60 to maintain a fluid tight seal between the valve stem 38 and the packing bore 42 during at least one of the plurality of cycles of rotation of the valve stem 38.

In an embodiment, the method may further comprise, in the event of a leak between the valve stem 38 and the packing system 60, venting fluid through an annular passage between the gland thruster 68 and the valve stem 38, and/or venting fluid through transverse passages through the weep holes 78 formed in the sleeve. In an embodiment, the method may further comprise visually observing transverse weep holes 78 formed in the sleeve 70 for fluid leakage using a sight line 88 within a range of observation angles provided between the valve body 12 and the gland thruster 68 past the reinforced section 74 and the flange 72. In an embodiment, the method may further comprise tensioning a plurality of compression bolts 82 to distally bias the gland thruster cap 80 against the flange 72 of the gland thruster 68.

In an embodiment, a method comprises rotating the valve stem such that the control element is in the closed position prior to or after applying a pressurized fluid having a pressure of greater than 275.8 MPa (40,000 psi) and a temperature of greater than or equal to about 200° C. to the inlet end of the fluid flow path or to the outlet end of the fluid flow path and maintaining the pressure and temperature for at least 1 hour, wherein the fluid is maintained by the valve without leaking, or at least without leaking through the packing bore. In an embodiment, the method my comprise rotating the valve stem such that the control element is in the closed position and prior to or before rotating the valve stem to close the valve, applying a pressurized fluid having a pressure of greater than 275.8 MPa (40,000 psi), or greater than 310.2 MPa (45,000 psi), or greater than 344.7 MPa (50,000 psi), at a temperature of greater than or equal to about 200° C., or greater than or equal to about 300° C., or greater than or equal to about 400° C., to the fluid flow bore, and maintaining the pressure and temperature for at least 1 hour, or for at least 5 hours, or for at least 24 hours, wherein the fluid is maintained by the valve without leaking, or wherein the fluid is maintained by the valve without leaking after a total of 5 cycles between the “on” position allowing flow and the “off” position which does not allow flow, or wherein the fluid is maintained by the valve without leaking after a total of 50 cycles, or wherein the fluid is maintained by the valve without leaking after a total of 1000 cycles. Accordingly, the ball valve according to any one or any combination of embodiments disclosed herein may be suitable for use under extremely high pressures (i.e., greater than 40,000 psi), and high temperatures (i.e., greater than or equal to about 200° C.).

### Embodiments

Accordingly, the instant disclosure relates to the following embodiments:
A. A valve, comprising:
   a valve body comprising a fluid flow path through a cavity;
   a flow control element located within the cavity;
   a valve seat to form a fluid seal between the flow control element and the valve body;
   a valve stem extending from a proximal end (away from the flow bore axis, adjacent any valve operator), through a packing bore formed in the valve body and disposed radially around the valve stem, to a distal end in rotational engagement with the flow control element to rotate the flow control element between open and closed position by rotating the valve stem; and
   a distally biased gland thruster disposed radially around the valve stem to compress a packing system disposed radially around the valve stem in the packing bore and comprising a plurality of packing rings and at least one proximal anti-extrusion ring disposed between the valve thruster and the packing rings.
B. The valve according to embodiment A, wherein the gland thruster comprises:
   a sleeve comprising an outside diameter closely approximating or matching an inside diameter of the packing bore, an inside diameter closely approximating or matching an outside diameter of the valve stem, and a distal end disposed to compress the packing system;
   a flange located at a proximal end of the gland thruster; and
   a reinforced section intermediate the sleeve and the flange having a wall thickness greater than a wall thickness of the sleeve.
C. The valve according to embodiment B, wherein the wall thickness of the reinforced section is at least 2 mm (0.080 in.) more than a wall thickness of the sleeve, preferably at least 4 mm (0.16 in.) more, or 8 mm (0.31 in.) more.
D. The valve according to any one of embodiments B to C, further comprising transverse weep holes formed in the sleeve.
E. The valve according to embodiment D wherein the weep holes have a diameter from 1 to 2 mm (or about 1.5 mm).
F. The valve according to any one of embodiments B to E, wherein the reinforced section of the gland thruster has an outside diameter less than an outside diameter of the flange.
G. The valve according to any one of embodiments B to F further comprising: a gland thruster cap disposed radially around the valve stem and adjacent the flange; and a plurality of compression bolts to distally bias the gland thruster cap against the flange of the gland thruster.
H. The valve according to any one of embodiments B to G, wherein the flange has an inside diameter closely approximating an outside diameter of the stem.
I. The valve according to any one of embodiments B to H, further comprising a chamfer at a proximal end of the packing bore, wherein the distal end of the sleeve is disposed between the chamfer and the packing system.
J. The valve according to any one of embodiments B to I, wherein the sleeve is joined to the reinforced section at a junction spaced away from a proximal end of the packing bore at a distance within 25% to 125% of the compression delta of the packing system (where compression delta is defined as the height of the packing with no compression minus the height of the compressed packing system).
K. The valve according to any one of the embodiments B to J, wherein the outside diameter of the sleeve matches the inside diameter of the packing bore, and the inside diameter of the sleeve matches the outside diameter of the valve stem.
L. The valve according to any one of the embodiments B to K, wherein the packing system comprises a packing ring assembly and a proximal anti-extrusion ring disposed between the distal end of the sleeve and the packing ring assembly.
M. The valve according to any one of the embodiments B to L, further comprising a distal anti-extrusion ring disposed between the packing ring assembly and a distal shoulder of the packing bore.
N. The valve according to embodiment L or embodiment M, wherein the packing ring assembly comprises a plurality of packing rings.
O. The valve according to any one of embodiments A to N, wherein the distal end of the valve stem comprises a polygonal profile comprising a plurality of stem profile sides dimensioned and arranged to engage a recess formed in the flow control element having a corresponding polygonal profile with a like plurality of recess sides, wherein rotation of the valve stem is transmitted to the flow control element through a like plurality of contact points between the stem profile sides and the recess sides.
P. The valve according to embodiment O, wherein the polygonal profile comprises a square (or rectangle) providing four contact points between the stem profile sides and the recess sides.
Q. The valve according to any one of embodiments A to P, wherein the valve is bidirectional.
R. The valve according to any one of embodiments A to Q, wherein the distal end of the valve stem comprises a profile comprising a plurality of sides dimensioned and arranged to engage a recess formed in the flow control element having a corresponding plurality of sides, wherein dimensions of the profile relative to the recess provide a spacing between the plurality of sides of the valve stem and the recess to allow for axial movement of the flow control element in the closed position, such that a fluid pressure applied to the flow control element in the closed position from either side of the flow path results in movement of the flow control element towards the other side of the flow path to activate sealing contact with the valve seat.
S. The valve according to any one of embodiments A to R, further comprising a shoulder formed on the valve stem with an enlarged outside diameter greater than an inside diameter of a blow-out stop disposed radially around the valve stem between the proximal end of the valve stem and the shoulder.
T. The valve according to embodiment S, wherein the blow-out stop is selected from a portion of the valve body, a portion of a bracket attached to the valve body, a bushing disposed around the valve stem, or a combination thereof.
U. The valve according to embodiment S, wherein the blow-out stop comprises a portion of a bracket attached to the valve body and a bushing disposed around the valve stem, wherein the shoulder is disposed between the bushing and the gland thruster and the bushing is disposed between the shoulder and the portion of the bracket.
V. A gland thruster to compress a packing system disposed radially around a valve stem in a packing bore, comprising:
   a sleeve comprising an outside diameter closely approximating an inside diameter of the packing bore, an inside diameter closely approximating an outside diameter of the valve stem, and a distal end disposed to compress the packing system;
   a flange located at a proximal end of the gland thruster; and
   a reinforced section intermediate the sleeve and the flange having a wall thickness greater than a wall thickness of the sleeve.
W. The gland thruster according to embodiment V, further comprising transverse weep holes formed in the sleeve.
X. The gland thruster according to embodiment V or embodiment W, wherein the reinforced section of the gland thruster has an outside diameter less than an outside diameter of the flange.
Y. The gland thruster according to any one of embodiments V to X, further comprising: a gland thruster cap disposed radially around the valve stem and adjacent the flange; and a plurality of compression bolts to distally bias the gland thruster cap against the gland thruster.
Z. The gland thruster according to any one of embodiments V to Y, wherein the outside diameter of the sleeve matches the inside diameter of the packing bore, and the inside diameter of the sleeve matches the outside diameter of the valve stem.
AA. A method of operating the valve according to any one of embodiments A to U, comprising:
   introducing a pressurized fluid into the flow path through the cavity formed in the valve body;
   rotationally engaging the flow control element with the distal end of the valve stem;
   rotating the valve stem to rotate the flow control element between open and closed position for a plurality of cycles; and
   distally biasing the gland thruster to compress the packing system to maintain a fluid tight seal between the valve stem and the packing bore during at least one of the plurality of cycles of rotation of the valve stem.
BB. A method, comprising:
   introducing a pressurized fluid into a flow path through a cavity formed in a valve body;
   rotationally engaging a flow control element located within the cavity with a distal end of a valve stem, the valve stem extending from a proximal end to the distal end through a packing bore formed in the valve body and disposed radially around the valve stem;
   rotating the valve stem to rotate the flow control element between open and closed position for a plurality of cycles; and
   distally biasing a gland thruster disposed radially around the valve stem to compress a packing system disposed radially around the valve stem in the packing bore to maintain a fluid tight seal between the valve stem and the packing bore during at least one of the plurality of cycles of rotation of the valve stem, wherein the gland thruster comprises:
      a sleeve comprising an outside diameter closely approximating an inside diameter of the packing bore, an inside diameter closely approximating an outside diameter of the valve stem, and a distal end disposed for the compression of the packing system;
      a flange located at a proximal end of the gland thruster; and
      a reinforced section intermediate the sleeve and the flange having a wall thickness greater than a wall thickness of the sleeve.
CC. The method of embodiment AA or embodiment BB, further comprising, in the event of a leak between the valve stem and the packing system, venting fluid through an annular passage between the gland thruster and the valve stem.
DD. The method of any one of embodiments AA to CC, further comprising, in the event of a leak between the valve stem and the packing system, venting fluid through transverse passages through weep holes formed in the sleeve.
EE. The method of any one of embodiments AA to DD, further comprising visually observing transverse weep holes formed in the sleeve for fluid leakage using a sight line within a range of observation angles provided between the valve body and the gland thruster past the reinforced section and the flange.
FF. The method of any one of embodiments AA to EE, further comprising tensioning a plurality of compression bolts to distally bias a gland thruster cap against the flange of the gland thruster.

The invention is described above in reference to specific examples and embodiments. The metes and bounds of the invention are not to be limited by the foregoing disclosure, which is illustrative only, but should be determined in accordance with the full scope and spirit of the appended claims. Various modifications will be apparent to those skilled in the art in view of the description and examples. It is intended that all such variations within the scope and spirit of the appended claims be embraced thereby.

What is claimed is:

1. A valve, comprising:
a valve body comprising a fluid flow path through a cavity;
a flow control element located within the cavity;
a valve seat to form a fluid seal between the flow control element and the valve body;
a valve stem extending from a proximal end, through a packing bore formed in the valve body and disposed radially around the valve stem, to a distal end in rotational engagement with the flow control element to rotate the flow control element between open and closed position by rotating the valve stem; and
a distally biased gland thruster disposed radially around the valve stem, comprising:
a sleeve comprising an outside diameter closely approximating an inside diameter of the packing bore, an inside diameter closely approximating an outside diameter of the valve stem, and a distal end disposed to compress a packing system disposed radially around the valve stem in the packing bore;
a flange located at a proximal end of the gland thruster; and
a reinforced section intermediate the sleeve and the flange having a wall thickness greater than a wall thickness of the sleeve.

2. The valve of claim 1, further comprising transverse weep holes formed in the sleeve.

3. The valve of claim 1, wherein the reinforced section of the gland thruster has an outside diameter less than an outside diameter of the flange.

4. The valve of claim 1, further comprising:
a gland thruster cap disposed radially around the valve stem and adjacent the flange; and
a plurality of compression bolts to distally bias the gland thruster cap against the flange of gland thruster.

5. The valve of claim 1, wherein the outside diameter of the sleeve matches the inside diameter of the packing bore, and the inside diameter of the sleeve matches the outside diameter of the valve stem.

6. The valve of claim 1, further comprising a chamfer at a proximal end of the packing bore, wherein the distal end of the sleeve is disposed between the chamfer and the packing system.

7. The valve of claim 1, wherein the sleeve is joined to the reinforced section at a junction spaced away from a proximal end of the packing bore at a distance within 25% to 125% of the compression delta of the packing system.

8. The valve of claim 1, wherein the packing system comprises a packing ring assembly and a proximal anti-extrusion ring disposed between the distal end of the sleeve and the packing ring assembly.

9. The valve of claim 8, further comprising a distal anti-extrusion ring disposed between the packing ring assembly and a distal shoulder of the packing bore.

10. The valve of claim 8, wherein the packing ring assembly comprises a plurality of packing rings.

11. The valve of claim 1, wherein the distal end of the valve stem comprises a polygonal profile comprising a plurality of stem profile sides dimensioned and arranged to engage a recess formed in the flow control element having a corresponding polygonal profile with a like plurality of recess sides, wherein rotation of the valve stem is transmitted to the flow control element through a like plurality of contact points between the stem profile sides and the recess sides.

12. The valve of claim 11, wherein the polygonal profile comprises a square providing four contact points between the stem profile sides and the recess sides.

13. The valve of claim 1, wherein the distal end of the valve stem comprises a profile comprising a plurality of sides dimensioned and arranged to engage a recess formed in the flow control element having a corresponding plurality of sides, wherein dimensions of the profile relative to the recess provide a spacing between the plurality of sides of the valve stem and the recess to allow for axial movement of the flow control element in the closed position, such that a fluid pressure applied to the flow control element in the closed position from either side of the flow path results in movement of the flow control element towards the other side of the flow path to activate sealing contact with the valve seat.

14. The valve of claim 1, further comprising a shoulder formed on the valve stem with an enlarged outside diameter greater than an inside diameter of a blow-out stop disposed radially around the valve stem between the proximal end of the valve stem and the shoulder.

15. The valve of claim 14, wherein the blow-out stop comprises a portion of a bracket attached to the valve body and a bushing disposed around the valve stem, wherein the shoulder is disposed between the bushing and the gland thruster and the bushing is disposed between the shoulder and the portion of the bracket.

16. A gland thruster to compress a packing system disposed radially around a valve stem in a packing bore, comprising:
a sleeve comprising an outside diameter closely approximating an inside diameter of the packing bore, an inside diameter closely approximating an outside diameter of the valve stem, and a distal end disposed to compress the packing system;
a flange located at a proximal end of the gland thruster; and
a reinforced section intermediate the sleeve and the flange having a wall thickness greater than a wall thickness of the sleeve.

17. The gland thruster of claim 16, further comprising one or more transverse weep holes formed in the sleeve.

18. The gland thruster of claim 16, wherein the reinforced section of the gland thruster has an outside diameter less than an outside diameter of the flange.

19. The gland thruster of claim 16, further comprising:
a gland thruster cap disposed radially around the valve stem and adjacent the flange; and
a plurality of compression bolts to distally bias the gland thruster cap against the gland thruster.

20. The gland thruster of claim 16, wherein the outside diameter of the sleeve matches the inside diameter of the packing bore, and the inside diameter of the sleeve matches the outside diameter of the valve stem.

21. A method, comprising:
introducing a pressurized fluid into a flow path through a cavity formed in a valve body;
rotationally engaging a flow control element located within the cavity with a distal end of a valve stem, the valve stem extending from a proximal end to the distal end through a packing bore formed in the valve body and disposed radially around the valve stem;
rotating the valve stem to rotate the flow control element between open and closed position for a plurality of cycles; and
distally biasing a gland thruster disposed radially around the valve stem to compress a packing system disposed radially around the valve stem in the packing bore to maintain a fluid tight seal between the valve stem and the packing bore during at least one of the plurality of cycles of rotation of the valve stem, wherein the gland thruster comprises:
a sleeve comprising an outside diameter closely approximating an inside diameter of the packing bore, an inside diameter closely approximating an outside diameter of the valve stem, and a distal end disposed for the compression of the packing system;
a flange located at a proximal end of the gland thruster; and
a reinforced section intermediate the sleeve and the flange having a wall thickness greater than a wall thickness of the sleeve.

22. The method of claim 21, further comprising, in the event of a leak between the valve stem and the packing system, venting fluid through an annular passage between the gland thruster and the valve stem.

23. The method of claim 21, further comprising, in the event of a leak between the valve stem and the packing system, venting fluid through one or more transverse passages through weep holes formed in the sleeve.

24. The method of claim 21, further comprising visually observing transverse weep holes formed in the sleeve for fluid leakage using a sight line provided between the valve body and the gland thruster past the reinforced section and the flange.

25. The method of claim 21, further comprising:
tensioning a plurality of compression bolts to distally bias a gland thruster cap against the flange of the gland thruster.
